(19) United States
(12) Patent Application Publication
(10) Pub. No.: US 2005/0071161 A1
(43) Pub. Date: Mar. 31, 2005

(54) Speech recognition method having relatively higher availability and correctiveness

(75) Inventor: Jia-Lin Shen, Taipei (TW)

Correspondence Address: BEVER HOFFMAN & HARMS, LLP;TRI-VALLEY OFFICE, 1432 CONCANNON BLVD., BLDG. G, LIVERMORE, CA, 94550, US

(73) Assignee: Delta Electronics, Inc., Taoyuan Hsien (TW)

(21) Appl. No.: 10/943,630

(22) Filed: Sep. 17, 2004

(30) Foreign Application Priority Data
Sep. 26, 2003 (TW) 92126732

(51) Int. Cl. G10L 15/00

(52) U.S. Cl. 704/236

(57) ABSTRACT

A method for more effectively recognizing a speech is proposed. The common habit of saying the same word again or even repeating the same word for several times when an oral instruction given by a person to a machine is not accepted at the first time is employed in the present invention. The consequences of being successively rejected twice or even several times and having no output of the conventional speech recognition system can be remedied properly through employing the proposed method so as to have a relatively higher availability and correctiveness.

### FIELD OF THE INVENTION

The present invention relates to a speech recognition method. More specifically, this invention relates to a speech recognition method employed in the man-machine interface.

### BACKGROUND OF THE INVENTION

Speech is the most naturally and conveniently employed as communication tool between human beings, and the speech recognition skills have been developed continuously for using in the man-machine interface. Due to the fact that the conventional ways of speech recognition could not reach the 100% correctiveness, the speech recognition systems are not widely used in the field of the man-machine interface.

Please refer to FIG. 1, it shows the schematic diagram of a conventional speech recognition system. In which, the speech recognition system 1 includes a speech recognition engine 11 and a result-judging mechanism 12. The voice of the user can be viewed as a speech signal and is input to the speech recognition engine 11, and the best recognition result will be input to the result-judging mechanism 12. When the score of the best recognition result is larger than a threshold, the best recognition result will be accepted and outputted by the speech recognition system 1. On the contrary, if the score of the best recognition result is less than a threshold, the best recognition result will be viewed as unreliable and rejected by the speech recognition system 1. The advantages of the result-judging mechanism 12 are that the unreliable results can be filtered and the reliability of the speech recognition can be reinforced. But under certain circumstances like the bad accents, and the unclear pronunciations of words and syllables, the best recognition result of the speech recognition engine would be rejected by the result-judging mechanism 12, and there is no result at all for outputting. On this occasion, the user will usually repeat the word again or even several times. But the best recognition result would be rejected by the same speech recognition system 1 usually. Relatively, this kind of recognition system 1 has the higher reliability, and the lower availability.

Keeping the drawbacks of the prior arts in mind, and employing experiments and research full-heartily and persistently, the applicant finally conceived the speech recognition method having relatively higher availability and correctiveness.

### SUMMARY OF THE INVENTION

It is therefore an object of the present invention to propose a method having relatively higher availability and correctiveness for recognizing a speech. The common habit of saying the same word again or even repeating the same word for several times when a given oral instruction from a person to a machine is not accepted at the first time is employed such that the consequences of being successively rejected twice or even several times and having no output of the conventional speech recognition system can be remedied properly so as to have a relatively higher availability and correctiveness.

According to the aspect of the present invention, the method for recognizing a speech includes the steps of: (a) providing a first speech signal at a first time; (b) generating a first candidate and a first recognition score according to the first speech signal; (c) judging whether the first recognition score is larger than a first threshold, and if not, going to a step (d); (d) judging whether the first recognition score is larger than a second threshold, and if yes, storing the first speech signal and going to a step (e); (e) providing a second speech signal at a second time; (f) generating a second candidate and a second recognition score according to the second speech signal; (g) judging whether the second recognition score is larger than the first threshold, and if not, going to a step (h); (h) judging whether the second recognition score is larger than the second threshold, and if yes, going to a step (i); (i) judging whether two conditions of: (i1) a result of the second time minus the first time being less than a certain time period and (i2) the second candidate being the same as the first candidate are both true at the same time, and if yes, going to a step (j); (j) finding the stored first speech signal and comparing the first speech signal with the second speech signal so as to generate a comparison score; and (k) judging whether the first comparison score is larger than a third threshold, and if yes, outputting the first candidate.

Preferably, the first threshold is larger than the second threshold.

Preferably, the contents of the first speech signal and the second speech signal are the same.

Preferably, the step (c) further includes a step (c′) of: outputting the first candidate if the first recognition score is larger than the first threshold.

Preferably, the step (d) further includes a step (d′) of: ending the method if the first recognition score is one of being identical to and being less than the second threshold.

Preferably, the step (g) further includes a step (g′) of: deleting the stored first speech signal and outputting the second candidate if the second recognition score is larger than the first threshold.

Preferably, the step (h) further includes a step (h′) of: ending the method if the second recognition score is one of being identical to and being less than the second threshold.

Preferably, the step (i) further includes a step (i′) of: deleting the stored first speech signal, storing the second speech signal, providing a third speech signal at a third time, and repeating the steps (e) to (i) with the second and the third speech signals respectively employed to replace the first and the second speech signals if the two conditions (i1) and (i2) are not simultaneously true.

Preferably, the contents of the first, the second, and the third speech signals are all the same.

Preferably, the first speech signal and the second speech signal are compared by one selected from a group consisting of Hidden Markov Models, Dynamic Time Warping, and Neural Networks.

According to another aspect of the present invention, the method for recognizing a speech includes the steps of: (a) providing a first speech signal at a first time; (b) generating a first candidate and a first recognition score according to the first speech signal; (c) judging whether the first recognition score is larger than a first threshold, and if not, going to a step (d); (d) judging whether the first recognition score is larger than a second threshold, and if yes, storing the first speech signal and going to a step (e); (e) providing a second speech signal at a second time; (f) generating a second candidate and a second recognition score according to the second speech signal; (g) judging whether the second recognition score is larger than the first threshold, and if not, going to a step (h); (h) judging whether the second recognition score is larger than the second threshold, and if yes, going to a step (i); (i) judging whether two conditions of: (i1) a result of the second time minus the first time being less than a certain time period and (i2) the second candidate being the same as the first candidate are both true at the same time, and if yes, going to a step (j); (j) finding the stored first speech signal and comparing the first speech signal with the second speech signal so as to generate a first comparison score; (k) judging whether the first comparison score is larger than a third threshold, and if not, storing the second candidate and going to a step (l); (l) providing a third speech signal at a third time; (m) finding the stored first and the second speech signals and cross-comparing the first and the second speech signals with the third speech signal so as to generate a second comparison score; and (n) judging whether the second comparison score is larger than the third threshold, and if yes, outputting the first candidate.

Preferably, the first threshold is larger than the second threshold.

Preferably, the contents of the first speech signal, the second speech signal, and the third speech signal are all the same.

Preferably, the step (c) further includes a step (c′) of: outputting the first candidate if the first recognition score is larger than the first threshold.

Preferably, the step (d) further includes a step (d′) of: ending the method if the first recognition score is one of being identical to and being less than the second threshold.

Preferably, the step (g) further includes a step (g′) of: deleting the stored first speech signal and outputting the second candidate if the second recognition score is larger than the first threshold.

Preferably, the step (h) further includes a step (h′) of: ending the speech recognition method if the second recognition score is one of being identical to and being less than the second threshold.

Preferably, the first step (i) further includes a step (i′) of: deleting the stored first speech signal, storing the second speech signal, providing a fourth speech signal at a fourth time, and repeating the steps (e) to (i) with the second and the fourth speech signals respectively employed to replace the first and the second speech signals if the two conditions (i1) and (i2) are not simultaneously true.

Preferably, the contents of the first speech signal, the second speech signal, and the fourth speech signal are all the same.

Preferably, the first speech signal and the second speech signal in the step (j) are compared by one selected from a group consisting of Hidden Markov Models, Dynamic Time Warping, and Neural Networks.

Preferably, the step (k) further includes a step (k′): outputting the first candidate if the first comparison score is larger than the third threshold.

Preferably, the first, the second speech signals and the third speech signal in the step (m) are cross-compared by one selected from a group consisting of Hidden Markov Models, Dynamic Time Warping, and Neural Networks.

Preferably, the step (n) further includes a step (n′) of: ending the method if the second comparison score is one of being identical to and being less than the third threshold.

The present invention may best be understood through the following descriptions with reference to the accompanying drawings, in which:

### BRIEF DESCRIPTION OF THE DRAWINGS

FIG. 1 is the schematic diagram of a conventional speech recognition system in the prior art;

FIG. 2 is the block diagram of the preferred embodiment of the present invention; and

FIG. 3 shows the flow chart of the re-confirmation mechanism of FIG. 2.

### DETAILED DESCRIPTION OF THE PREFERRED EMBODIMENT

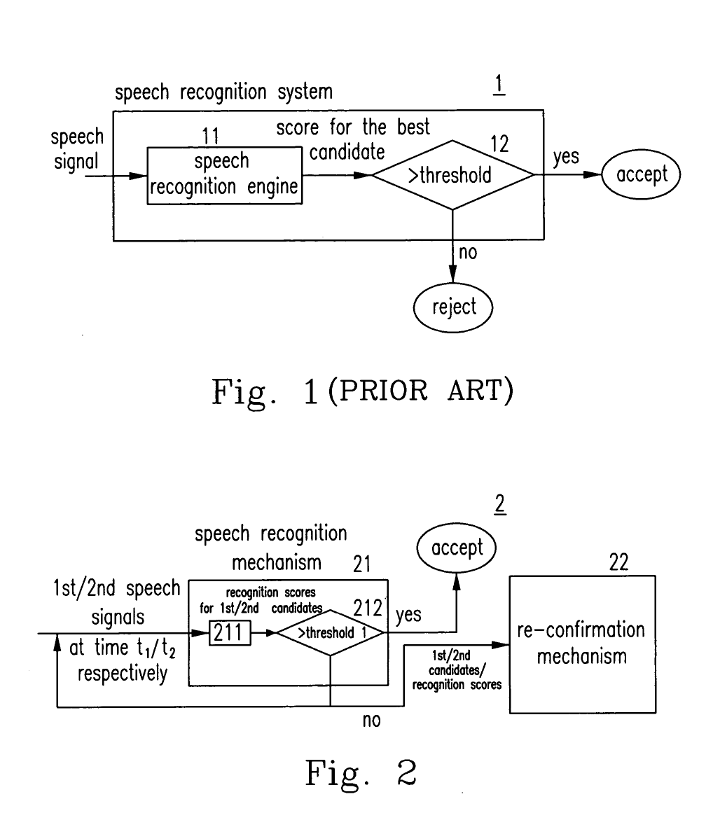

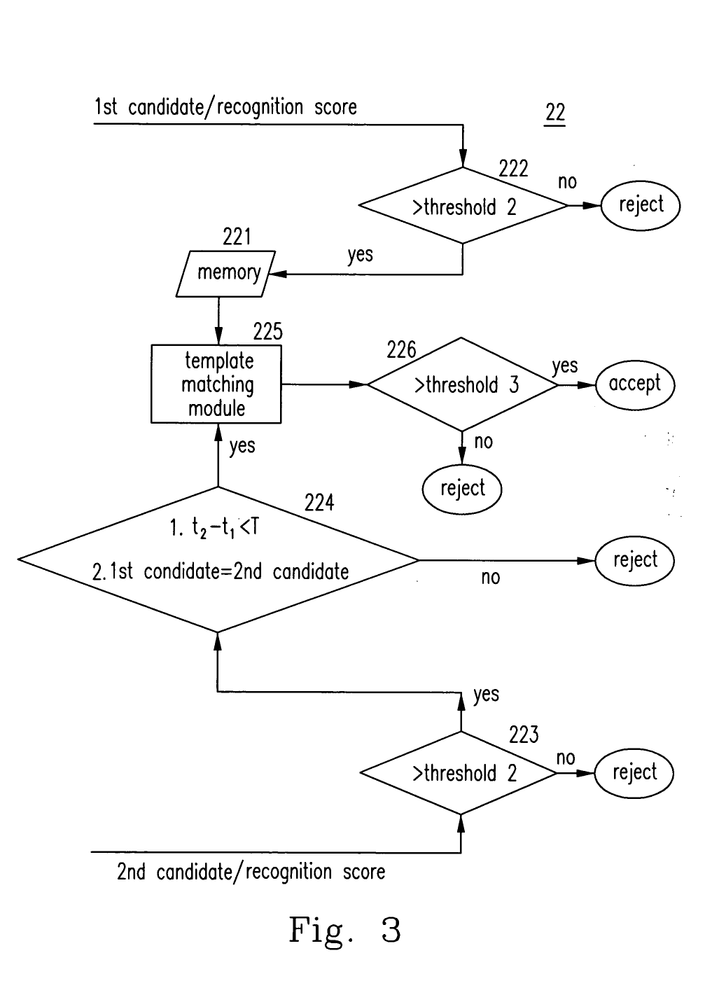

Please refer to FIG. 2, it shows the block diagram of the preferred embodiment of the present invention 2. In FIG. 2, the proposed speech recognition system 2 includes a speech recognition mechanism 21 and a re-confirmation mechanism 22. The prior half of the preferred embodiment of the present invention 2, the speech recognition mechanism 21 which includes a speech recognition engine 211 and a result-judging mechanism 212 having a threshold 1, is the same as the conventional speech recognition system 1 as shown in FIG. 1. When the user pronounces a first speech signal at the first time, the speech recognition mechanism 21 will generate a first candidate and a first recognition score, and whether the first recognition score is larger than a pre-determined first threshold (threshold 1) of the speech recognition mechanism 21 will be judged. If yes, the first candidate will be output by the speech recognition mechanism 21. But, the important thing is that the speech recognition mechanism 21 of the present invention would store the first speech signal in a memory 221 (as shown in FIG. 3) and wait for the user to repeat the first speech signal again if the first speech signal is not accepted by the speech recognition mechanism 21 such that the first/second speech signals can be reconfirmed. The common habit of the users of saying the same word again when a given oral instruction to a machine is not accepted at the first time is employed by the proposed speech recognition system of the present invention 2 to add a re-confirmation mechanism 22 onto the conventional speech recognition system (the speech recognition mechanism 21 of the present invention) so as to have a relatively higher availability and correctiveness, and maintain the same level of reliability in the meantime.

When the user pronounces the second speech signal at a second time t2, which has the same contents as the first speech signal input at a first time t1, the speech recognition mechanism 21 will generate a second candidate and a second recognition score by the speech recognition engine 211 according to the second speech signal firstly, and whether the second recognition score is larger than the first threshold (threshold 1) will be judged by the result-judging mechanism 212 secondly. If yes, the first speech signal stored in the memory 221 (as shown in FIG. 3) will be deleted and the second candidate will be output by the speech recognition mechanism 21 thirdly. If not, the first and the second candidates/recognition scores will be input to the reconfirmation mechanism 22 as shown in FIG. 2.

Please refer to FIG. 3, which is the schematic diagram of the flow-chart of the re-confirmation mechanism 22 of FIG. 2. Except for the original threshold 1 of the speech recognition mechanism 21, there are two extra thresholds, the second threshold (threshold 2) and the third threshold (threshold 3) added into the re-confirmation mechanism 22 as shown in FIG. 3. In which, the second threshold is less than the first threshold in order to maintain the same level of reliability for the results of speech recognition.

In FIG. 3, when the first recognition score of the first candidate is less than the first threshold (threshold 1), the first recognition score and the second threshold (threshold 2) would be compared by a first re-confirmation mechanism 222 firstly, and when the second recognition score of the second candidate is less than the first threshold (threshold 1), the second recognition score and the second threshold (threshold 2) would be compared by a second re-confirmation mechanism 223 secondly. If the second recognition score of the second candidate is less than or equal to the second threshold (threshold 2), no output will be generated from the proposed speech recognition system 2. On the contrary, if the first and second recognition scores are both less than the first threshold (threshold 1) but larger than the second threshold (threshold 2), one thing would be recognized by the proposed speech recognition system 2 that is the user has repeated the same oral instruction twice. At this moment, whether the following two conditions are both fulfilled would be judged by a third re-confirmation mechanism 224 of the proposed speech recognition system 2:

1. the result of (t2-t1) is less than a pre-determined time period T; and

2. the first candidate is equal to the second candidate.

If the above two conditions 1 and 2 are not true simultaneously, there is not any message would be output by the proposed speech recognition system 2. On the other hand, if the conditions 1 and 2 are both true at the same time, one thing would be recognized by the proposed speech recognition mechanism 21 that is the first and the second speech signals are actually the same instruction, and the first and the second speech signals will be input to a templates matching module 225 of the re-confirmation mechanism 22 for a comparison. The comparison methodology employed in the templates matching module 225 is selected from a group consisting of Hidden Markov Models, Dynamic Time Warping, Neural Networks and other known methodologies.

Besides, a third threshold (threshold 3 as shown in FIG. 3) is added to reconfirm whether the output from the templates matching module 225 has an acceptable reliability. The first and the second speech signals are compared by the templates matching module 225 so as to generate a first comparison score, and the generated first comparison score is input to a fourth re-confirmation mechanism 226. If the first comparison score is larger than the third threshold (threshold 3), which means the user has input the same oral instruction twice, and the first and second speech signals were both rejected by the speech recognition mechanism 21 at the first time due to the relatively lower reliability generated by factors like the bad accents, etc. firstly. But, the identification result is considered acceptable by the re-confirmation mechanism 22, and the original best candidate, that is the first candidate, would be output by the proposed speech recognition system 2 secondly. Otherwise, if the first comparison score is less than or equal to the third threshold (threshold 3), there is not any message would be output by the proposed speech recognition system 2.

Furthermore, the functions of the re-confirmation mechanism 22 can be enlarged to handle the multiple speech signals reconfirmation. For example, if the above-mentioned conditions 1 and 2 are not true simultaneously, there is not any message output by the proposed speech recognition system 2 firstly. Instead, the stored first speech signal is deleted, and the second speech signal is stored secondly. When a third speech signal is pronounced by the user at a third time (having the same contents as the first and the second speech signals), the second and the third speech signals are employed to replace the first and the second speech signals, and they would be input to the re-confirmation mechanism 22 again thirdly. Besides, when the first comparison score generated by the templates matching module 225 is less than or equal to the third threshold (threshold 3), instead of giving no output, both the first and the second speech signals would be stored by the proposed speech recognition system 2 fourthly. When a fourth speech signal is pronounced by the user at a fourth time (having the same contents as the first and the second speech signals), the first and the second speech signals are cross-compared with the fourth speech signal by the templates matching modules 225 to generate a second comparison score fifthly. If the second comparison score is larger than the third threshold (threshold 3), the first candidate would be output by the proposed speech recognition system 2, otherwise, there is not any message would be output by the proposed speech recognition system 2 lastly.

According to the above descriptions, a method having relatively higher availability and correctiveness for recognizing a speech is proposed. The common habit of saying the same word again or even repeating the same word for several times when a given oral instruction from a person to a machine is not accepted at the first time is employed such that the consequences of being successively rejected twice or even several times and having no output of the conventional speech recognition system can be remedied. Through employing the re-confirmation mechanism of the proposed method, the speech recognition system of the present invention, which could be applied to the field of the man-machine interface, would have the relatively higher availability and correctiveness.

In conclusion, the speech recognition system of the present invention has the following advantages: achieving the relatively higher availability and correctiveness and keeping the same level of the reliability in the meantime.

While the invention has been described in terms of what are presently considered to be the most practical and preferred embodiments, it is to be understood that the invention need not be limited to the disclosed embodiment. On the contrary, it is intended to cover various modifications and similar arrangements included within the spirit and scope of the appended claims, which are to be accorded with the broadest interpretation so as to encompass all such modifications and similar structures. Therefore, the above description and illustration should not be taken as limiting the scope of the present invention which is defined by the appended claims.

1. A method for recognizing a speech, comprising the steps of:
(a) providing a first speech signal at a first time;
(b) generating a first candidate and a first recognition score according to said first speech signal;
(c) judging whether said first recognition score is larger than a first threshold, and if not, going to a step (d);
(d) judging whether said first recognition score is larger than a second threshold, and if yes, storing said first speech signal and going to a step (e);
(e) providing a second speech signal at a second time;
(f) generating a second candidate and a second recognition score according to said second speech signal;
(g) judging whether said second recognition score is larger than said first threshold, and if not, going to a step (h);
(h) judging whether said second recognition score is larger than said second threshold, and if yes, going to a step (i);
(i) judging whether two conditions of: (i1) a result of said second time minus said first time being less than a certain time period and (i2) said second candidate being the same as said first candidate are both true at the same time, and if yes, going to a step (j);
(j) finding said stored first speech signal and comparing said first speech signal with said second speech signal so as to generate a comparison score; and
(k) judging whether said comparison score is larger than a third threshold, and if yes, outputting said first candidate.

2. The method according to claim 1, wherein said first threshold is larger than said second threshold.

3. The method according to claim 1, wherein the contents of said first speech signal and said second speech signal are the same.

4. The method according to claim 1, wherein said step (c) further comprises a step (c′) of: outputting said first candidate if said first recognition score is larger than said first threshold.

5. The method according to claim 1, wherein said step (d) further comprises a step (d′) of: ending said method if said first recognition score is one of being identical to and being less than said second threshold.

6. The method according to claim 1, wherein said step (g) further comprises a step (g′) of: deleting said stored first speech signal and outputting said second candidate if said second recognition score is larger than said first threshold.

7. The method according to claim 1, wherein said step (h) further comprises a step (h′) of: ending said method if said second recognition score is one of being identical to and being less than said second threshold.

8. The method according to claim 1, wherein said step (i) further comprises a step (i′) of: deleting said stored first speech signal, storing said second speech signal, providing a third speech signal at a third time, and repeating said steps (e) to (i) with said second and said third speech signals respectively employed to replace said first and said second speech signals if said two conditions (i1) and (i2) are not simultaneously true.

9. The method according to claim 8, wherein the contents of said first, said second, and said third speech signals are all the same.

10. The method according to claim 1, wherein said first speech signal and said second speech signal are compared by one selected from a group consisting of Hidden Markov Models, Dynamic Time Warping, and Neural Networks.

11. The method according to claim 1, wherein said step (k) further comprises one of the following steps:
(k1) ending said method if said comparison score is one of being identical to and being less than said third threshold; and
(k2) deleting said stored first speech signal, storing said second speech signal, providing a fourth speech signal at a fourth time, and repeating said steps (e) to (k) with said second and said fourth speech signals respectively employed to replace said first and said second speech signals if said comparison score is one of being identical to and being less than said third threshold.

12. The method according to claim 11, wherein the contents of said first, said second, and said fourth speech signals are all the same.

13. A method for recognizing a speech, comprising the steps of:
(a) providing a first speech signal at a first time;
(b) generating a first candidate and a first recognition score according to said first speech signal;
(c) judging whether said first recognition score is larger than a first threshold, and if not, going to a step (d);
(d) judging whether said first recognition score is larger than a second threshold, and if yes, storing said first speech signal and going to a step (e);
(e) providing a second speech signal at a second time;
(f) generating a second candidate and a second recognition score according to said second speech signal;
(g) judging whether said second recognition score is larger than said first threshold, and if not, going to a step (h);
(h) judging whether said second recognition score is larger than said second threshold, and if yes, going to a step (i);
(i) judging whether two conditions of: (i1) a result of said second time minus said first time being less than a certain time period and (i2) said second candidate being the same as said first candidate are both true at the same time, and if yes, going to a step(j);
(j) finding said stored first speech signal and comparing said first speech signal with said second speech signal so as to generate a first comparison score;
(k) judging whether said first comparison score is larger than a third threshold, and if not, storing said second candidate and going to a step (l);
(l) providing a third speech signal at a third time;
(m) finding said stored first and said second speech signals and cross-comparing said first and said second speech signals with said third speech signal so as to generate a second comparison score; and
(n) judging whether said second comparison score is larger than said third threshold, and if yes, outputting said first candidate.

14. The method according to claim 13, wherein said first threshold is larger than said second threshold.

15. The method according to claim 13, wherein the contents of said first speech signal, said second speech signal, and said third speech signal are all the same.

16. The method according to claim 13, wherein said step (c) further comprises a step (c′) of: outputting said first candidate if said first recognition score is larger than said first threshold.

17. The method according to claim 13, wherein said step (d) further comprises a step (d′) of: ending said method if said first recognition score is one of being identical to and being less than said second threshold.

18. The method according to claim 13, wherein said step (g) further comprises a step (g′) of: deleting said stored first speech signal and outputting said second candidate if said second recognition score is larger than said first threshold.

19. The method according to claim 13, wherein said step (h) further comprises a step (h′) of: ending said speech recognition method if said second recognition score is one of being identical to and being less than said second threshold.

20. The method according to claim 13, wherein said first step (i) further comprises a step (i′) of: deleting said stored first speech signal, storing said second speech signal, providing a fourth speech signal at a fourth time, and repeating said steps (e) to (i) with said second and said fourth speech signals respectively employed to replace said first and said second speech signals if said two conditions (i1) and (i2) are not simultaneously true.

21. The method according to claim 20, wherein the contents of said first speech signal, said second speech signal, and said fourth speech signal are all the same.

22. The method according to claim 13, wherein said first speech signal and said second speech signal in said step (j) are compared by one selected from a group consisting of Hidden Markov Models, Dynamic Time Warping, and Neural Networks.

23. The method according to claim 13, wherein said step (k) further comprises a step (k′): outputting said first candidate if said first comparison score is larger than said third threshold.

24. The method according to claim 13, wherein said first, said second speech signals and said third speech signal in said step (m) are cross-compared by one selected from a group consisting of Hidden Markov Models, Dynamic Time Warping, and Neural Networks.

25. The method according to claim 13, wherein said step (n) further comprises a step (n′) of: ending said method if said second comparison score is one of being identical to and being less than said third threshold.
